(19) United States
(12) Patent Application Publication
(10) Pub. No.: US 2008/0088409 A1
(43) Pub. Date: Apr. 17, 2008

(54) Vehicle control system

(75) Inventors: Noriaki Okada, Chiryu-city (JP); Hiromichi Naitoh, Okazaki-city (JP); Munenori Matsumoto, Kariya-city (JP); Mitsugi Ootsuka, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/907,449

(22) Filed: Oct. 12, 2007

(30) Foreign Application Priority Data
Oct. 17, 2006 (JP) 2006-282647

(51) Int. Cl. G08C 19/00

(52) U.S. Cl. 340/5.2

(57) ABSTRACT

A smart portable device transmits a keyless radio signal for a keyless entry system by two frequency channels. In an integrated tuner, a control IC determines a frequency channel having a better communication state, and controls a frequency of a signal that is input to a mixer from a PLL circuit to a frequency for converting the keyless radio signal of the determined frequency channel into an intermediate frequency signal. This configuration makes it possible to share a circuit for receiving the keyless radio signals of those two frequency channels, and to receive the keyless radio signal of the frequency channel having the better communication state to surely conduct communication.

### CROSS REFERENCE TO RELATED APPLICATION

This application is based on and incorporates herein by reference Japanese Patent Application No. 2006-282647 filed on Oct. 17, 2006.

### FIELD OF THE INVENTION

The present invention relates to a vehicle control system, and more particularly to a keyless entry system.

### BACKGROUND OF THE INVENTION

A remote keyless entry system or a smart entry system is now in a practical use in a vehicle. In the remote keyless entry system, when a user of the vehicle depresses a button of his/her portable device, a radio wave including information specific to the vehicle is transmitted from the portable device to the vehicle, and the radio wave is received by an in-vehicle electronic device and authenticated, to thereby lock or unlock a door. In the smart entry system, when a user who has his/her portable device as an electronic key enters a radio communication area around a vehicle, a reply signal is transmitted from the portable device, and the reply signal is received by an in-vehicle electronic device and authenticated, to thereby allow a door to be unlocked, and the user is allowed to unlock the door, for example, by merely operating a switch that is disposed at the outer side of the door.

In a keyless entry system, which may be the above remote keyless entry system or the smart entry system, in order to ensure certainty of communication, plural frequency channels are used. In this case, when the communication is jammed by a disturbance, the present frequency channel is switched over to another frequency channel to conduct the normal communication. For example, switching over from the frequency channel of a transmission radio wave to another frequency channel is attained by operating an operation switch on a portable device (for example, JP 4-315681A).

A receiver circuit is provided in each of the frequency channels when the communication is conducted by the aid of the plural frequency channels. However, This will complicate system configuration and increase costs.

### SUMMARY OF THE INVENTION

The present invention therefore has an object to provide a keyless entry system that does not complicate system configuration.

According to one aspect of a vehicle control system, in an in-vehicle receiving device, a frequency converter circuit alternatively selects any keyless radio signal of plural channels, converts a selected keyless radio signal into an intermediate frequency signal, and also outputs the converted signal to a demodulator circuit for demodulation of the converted signal. For this reason, it is possible to share the frequency converter circuit by the plural channels, and hence it is unnecessary to dispose the frequency converter circuit in each of the channels. Also, a receiver antenna and the demodulator circuit are shared by the plural channels. Hence, the system configuration can be simplified.

Moreover, a keyless radio signal that is alternatively selected by the frequency converter circuit is a keyless radio signal of an optimum channel. This optimum channel is a channel that is best in a communication state, that is, a channel in which distortion of the keyless radio signal is the smallest. Thus, an error rarely occurs in the demodulated signal of the keyless radio signal of the optimum channel. In the in-vehicle receiving device, the optimum channel is automatically selected, and the data which is transmitted from the portable device can be precisely received. In JP 4-315681A, in order to change over from one frequency channel to another frequency channel, it is necessary to operate an operation switch at a portable device side. For example, when a user recognizes that the communication is not normally conducted, the user operates the operation switch to change over from the present frequency channel to another frequency channel. In this case, the communication is not normally conducted until the frequency channel is changed over to another frequency channel. Also, it is likely that the communication that is made by the switched frequency channel cannot be normally conducted. Those are because the communication maybe jammed by the disturbance, and the user does not actually understand whether there is the disturbance or not.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic diagram showing a vehicle control system according to a first embodiment of the present invention;

FIG. 2 is a flowchart showing a receiving channel setting process which is executed by a control IC;

FIG. 3 is a flowchart showing a process that is executed in communication of a remote keyless entry system by the control IC;

FIG. 4 is a flowchart showing a receiving channel setting process which is executed by the control IC;

FIG. 5 is a flowchart showing a process that is executed in communication of a smart entry system by the control IC;

FIG. 6 is a flowchart showing a receiving channel setting process which is executed by the control IC (RSSI level measurement);

FIG. 7 is an explanatory diagram showing a keyless radio signal;

FIG. 8 is a flowchart showing a process that is executed in communication of the remote keyless entry system by the control IC;

FIG. 9 is a flowchart showing a process that is executed in communication of the smart entry system by the control IC;

FIG. 10 is a schematic diagram showing a vehicle control system according to a second embodiment of the present invention;

FIG. 11 is a flowchart showing a process that is executed in communication of the remote keyless entry system by the control IC;

FIG. 12 is a flowchart showing a process that is executed in communication of the smart entry system by the control IC; and

FIG. 13 is a schematic diagram showing a vehicle control system according to a third embodiment of the present invention.

### DETAILED DESCRIPTION OF THE PREFERRED EMBODIMENTS

### First Embodiment

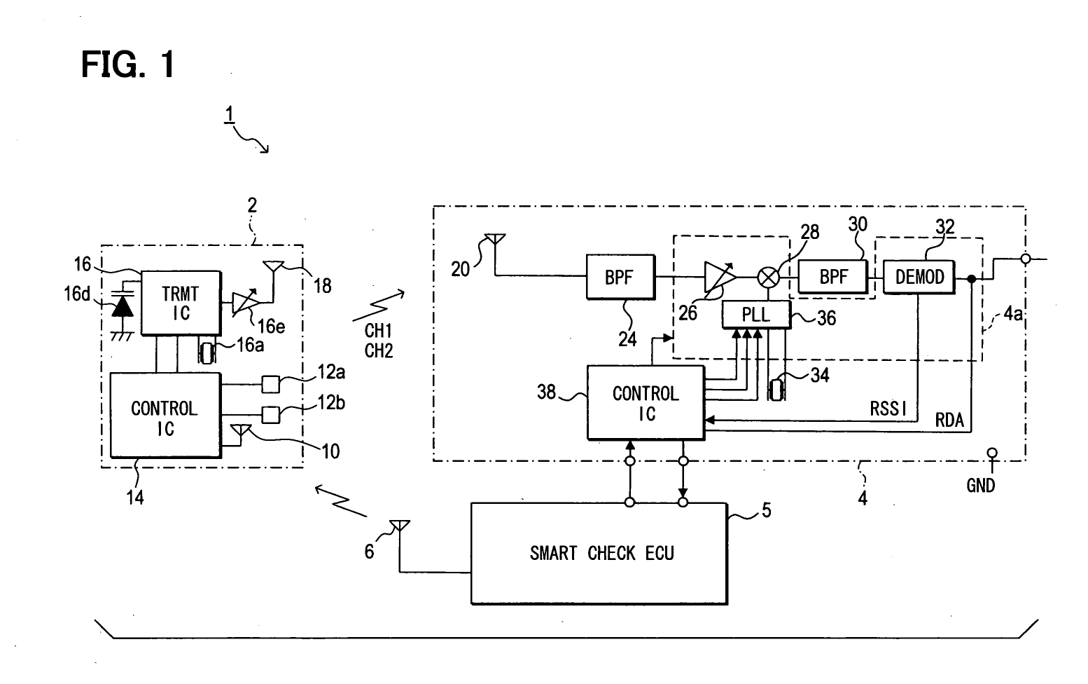

Referring first to FIG. 1, a vehicle control system 1 has functions of a remote keyless entry (RKE) system and a smart entry system. The vehicle control system 1 includes a smart portable device 2 that is carried by a user of a vehicle, an integrated tuner 4 that is mounted in the vehicle, a smart check ECU 5, and an antenna 6.

The remote keyless entry system is capable of locking or unlocking a door at a place that is apart from the vehicle by operating a lock switch 12a or an unlock switch 12b of the smart portable device 2 by the user. Also, the smart entry system unlocks the door, for example, when the user of the vehicle touches a door handle (not shown) in a state where the user carries the smart portable device 2 and approaches the vehicle.

The smart portable device 2 includes an antenna 10 for receiving a radio signal that is transmitted from the antenna 6 which is mounted in the vehicle, a control integrated circuit (IC) 14 that controls the function of the smart portable device 2, an antenna 18 for transmitting a radio signal to the integrated tuner 4, a transmission IC 16 for supplying a radio signal to the antenna 18, an oscillator 16a and a variable capacitance diode 16d which are connected to the transmission IC 16, and an amplifier 16e that is connected between the transmission IC 16 and the antenna 18. The lock switch 12a may be a button type which is depressed when the door of the vehicle is to be locked. The unlock switch 12b may be a button type which is depressed when the door of the vehicle is to be unlocked.

The transmission IC 16 includes a known phase-locked loop (PLL) circuit using a voltage-controlled oscillator (VCO), and supplies a phase comparison output signal between the output frequency of the VCO and a reference frequency signal from the oscillator 16a to a control voltage terminal (a terminal for controlling a capacitance) of the variable capacitance diode 16d through a loop filter. With the above configuration, a stable oscillation frequency is obtained. Also, a desired oscillation frequency resulting from dividing or multiplying the frequency of the reference frequency signal is obtained. In addition, the transmission IC 16 controls a supply voltage to a control voltage terminal of the variable capacitance diode 16d, separately, to thereby control the oscillation frequency to a desired value.

When the oscillator 16a is represented by an equivalent circuit including a capacitor C, a coil L, and a resistor R, the capacitance of the variable capacitance diode 16d changes due to the supply voltage to the control voltage terminal of the variable capacitance diode 16d, and the reactance of the equivalent circuit changes with a change in the capacitance. For this reason, a resonance frequency of the equivalent circuit changes, causing a change in the oscillation frequency. This is known by, for example, JP 3-129908A.

Then, in this example, the transmission IC 16 generates a signal of 312. 15 MHz or a signal of 314.35 MHz, and controls the supply voltage to the control voltage terminal of the variable capacitance diode 16d on the basis of transmission data to be transmitted, and generates a modulation signal. In this embodiment, the signal of 312.15 MHz band is channel (Ch)1, and the signal of 312.15 MHz band is Ch2.

The integrated tuner 4 includes an antenna 20 for receiving the radio signal of Ch1 (first transmission radio wave) and the radio signal of Ch2 (second transmission radio wave), and a band pass filter (BPF) 24 that allows the first transmission radio wave and the second transmission radio wave received by the antenna 20 to pass therethrough, and removes other undesired signals. The integrated tuner 4 also includes an amplifier circuit (AMP) 26 that amplifies the signal that has passed through the BPF 24, a mixer 28 that mixes a receiver signal from the amplifier 26 with a signal of a local frequency which is input from a PLL circuit 36 to convert the receiver signal into an intermediate frequency signal of a specific frequency, and an oscillator 34 that generates a reference signal of a given frequency.

The integrated tuner 4 further includes a PLL circuit 36 that divides or multiplies the frequency of the reference signal which is output from the oscillator 34 to generate a signal of a desired local frequency on the basis of a signal that is input from a control IC 38 that controls the function of the integrated tuner 4, and then inputs the generated signal to the mixer 28, a band pass filter (BPF) 30 that allows an intermediate frequency signal of a specific frequency which has been generated by the mixer 28 to selectively pass therethrough, and a demodulator circuit 32 that demodulates the intermediate frequency signal of the specific frequency which has passed through the BPF 30. The amplifier 26, the mixer 28, the demodulator circuit 32, and the PLL circuit 36 constitute a receiver IC 4a. That is, the receiver IC 4a is one IC package.

The control IC 38 detects the demodulated signal RDA of the first transmission radio wave and the demodulated signal RDA of the second transmission radio wave from the receiver IC 4a. The control IC 38 also detects the signal strength (voltage level) RSSI of the demodulated signal from the detected demodulated signal. In a state where the first transmission radio wave or the second transmission radio wave is not received from the antenna 20, the demodulated signal is not output from the demodulator circuit 32. In this case, the noise level is detected.

In the case of the smart entry system, when a sensor detects that the user touches, for example, a door handle, the smart check ECU 5 transmits a request signal in radio wave from the antenna 6 that is mounted in the vehicle to the smart portable device 2. Upon receiving the request signal from the antenna 10, the smart portable device 2 transmits the first transmission radio wave or the second transmission radio wave including a smart entry system code (smart code) through the antenna 18. The smart code is a code specific to the vehicle using the smart portable device 2.

In the integrated tuner 4, the receiving channel is set to Ch1 or Ch2 in advance, and the first transmission radio wave or the second transmission radio wave which is transmitted from the smart portable device 2 is demodulated. Then, the smart check ECU 5 (or the control IC 38) checks the smart code included in the demodulation signal against the code specific to the vehicle. When the smart check ECU 5 determines that those codes coincide with each other, the smart check ECU 5 unlocks the door of the vehicle.

In the case of the remote keyless entry system, when the lock switch 12a of the smart portable device 2 is depressed by the user, the smart portable device 2 transmits the first transmission radio wave or the second transmission radio wave including a lock command code for commanding the locking of the door through the antenna 18. When the unlock switch 12b of the smart portable device 2 is depressed by the user, the smart portable device 2 transmits the first transmission radio wave or the second transmission radio wave including an unlock command code for commanding the unlocking of the door through the antenna 18. The lock command code and the unlock command code are codes specific to the vehicle using the smart portable device 2.

In the integrated tuner 4, as in the smart entry system, the receiving channel is set to Ch1 or Ch2 in advance, and the first transmission radio wave or the second transmission radio wave which is transmitted from the smart portable device 2 is demodulated. Then, the smart check ECU 5 (or the control IC 38) checks the lock code or the unlock code included in the demodulation signal against the code specific to the vehicle. When the smart check ECU 5 determines that those codes coincide with each other, the smart check ECU 5 locks or unlocks the door of the vehicle.

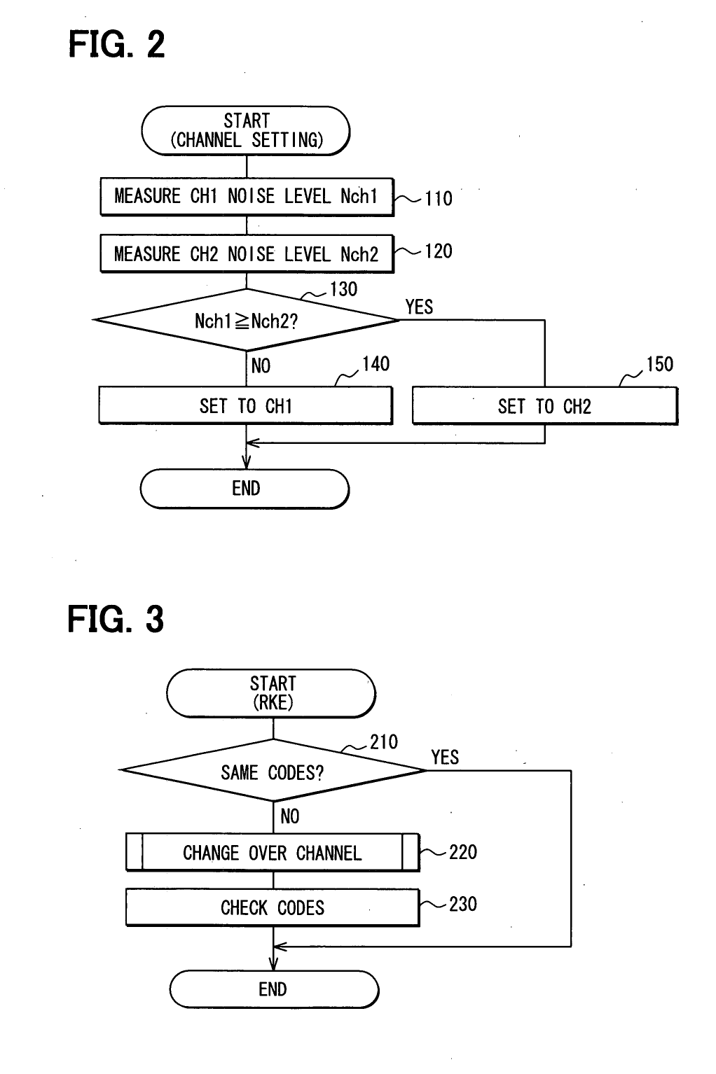

In each of the remote keyless entry system and the smart entry system, a receiving channel setting process shown in FIG. 2 is executed. This is a process for setting the receiving channel to any one of Ch1 and Ch2, and is periodically executed, for example, while the ignition switch of the vehicle is held off.

In the receiving channel setting process shown in FIG. 2, the noise level of Ch1 is measured in step 110. More specifically, in a non-radio wave state where the integrated tuner 4 does not receive the first transmission radio wave, the noise level is measured as Nch1 on the basis of the receiver IC 4a, more specifically, the voltage level of the signal which is detected from the demodulator circuit 32.

Subsequently, the processing is advanced to step 120, the noise level of Ch2 is measured as Nch2, and the processing is advanced to step 130.

In step 130, the noise level of Ch1 and the noise level of Ch2 are compared with each other, and it is determined whether or not the noise level of Ch1 is equal to or higher than the noise level of Ch2. When it is determined that the noise level of Ch1 is not equal to or higher than the noise level of Ch2, that is, the noise level of Ch1 is lower than the noise level of Ch2, the receiving channel is set to Ch1 in step 140. On the other hand, when it is determined in step 130 that the noise level of Ch1 is equal to or higher than the noise level of Ch2, the processing is advanced to step 150, and the receiving channel is set to Ch2.

In step 140, when the receiving channel is set to Ch1, the control IC 38 controls an input signal to the PLL circuit 36 so that the signal that is 301.45 MHz in the local frequency is determined by the PLL circuit 36. That is, the first transmission radio wave (312.15 MHz) is mixed with the signal that is 301.45 MHz in the local frequency so as to be converted into an intermediate frequency signal of 10.7 MHz band by means of the mixer 28. In this situation, in the case of receiving the second transmission radio wave (314.35 MHz), the second transmission radio wave is mixed with the signal that is 301.45 MHz in the local frequency so as to be converted into a signal of 12.9 MHz by means of the mixer 28. Then, only the intermediate frequency signal of 10.7 MHz which has been converted from the first transmission radio wave passes through the BPF 30, and is input to the demodulator circuit 32. The signal of 12.9 MHz that has been converted from the second transmission radio wave is removed by means of the BPF 30.

Also, the transmission command of the signal that is representative of Ch1 which has been set as the receiving channel is output to the smart check ECU 5. The smart check ECU 5 transmits the signal representative of Ch1 to the smart portable device 2 from the antenna 6 on the basis of the transmission command. The above processing corresponds to channel notifying means. In this case, the smart portable device 2 transmits the radio signal of Ch1 (that is, the first transmission radio wave).

On the other hand, when the receiving channel is set to Ch2 in step 150, the control IC 38 controls the input signal to the PLL circuit 36 so that the signal of the local frequency 303.65 MHz is generated by the PLL circuit 36. That is, the control is made such that the second transmission radio wave (314.35 MHz) is mixed with the signal that is 303.65 MHz in the local frequency so as to be converted into an intermediate frequency signal of 10.7 MHz band by means of the mixer 28. In this situation, in the case of receiving the first transmission radio wave (312.15 MHz), the first transmission radio wave is mixed with the signal that is 303.65 MHz in the local frequency so as to be converted into a signal of 8.5 MHz by means of the mixer 28. Then, only the intermediate frequency signal of 10.7 MHz which has been converted from the second transmission radio wave passes through the BPF 30, and is input to the demodulator circuit 32. The signal of 8.5 MHz that has been converted from the first transmission radio wave is removed by means of the BPF 30.

As described above, the receiving channel is set in advance, and the radio signal that has been transmitted through any one of Ch1 and Ch2 which is smaller in the noise level is demodulated. As a result, the probability that an error occurs in the demodulation signal is suppressed.

In the case of the communication of the remote keyless entry system, the control IC 38 executes the process shown in FIG. 3. First in step 210, a lock code or an unlock code which is included in the demodulated signal is checked against the code specific to the vehicle, and it is determined whether both of those codes are the same coinciding with each other or not. When it is determined that those codes coincide with each other, a signal representative of this fact is input to the smart check ECU 5 to complete the above process. The smart check ECU 5 locks the door when the coincident code is the lock code, and unlocks the door when the coincident code is the unlock code, on the basis of the input signal.

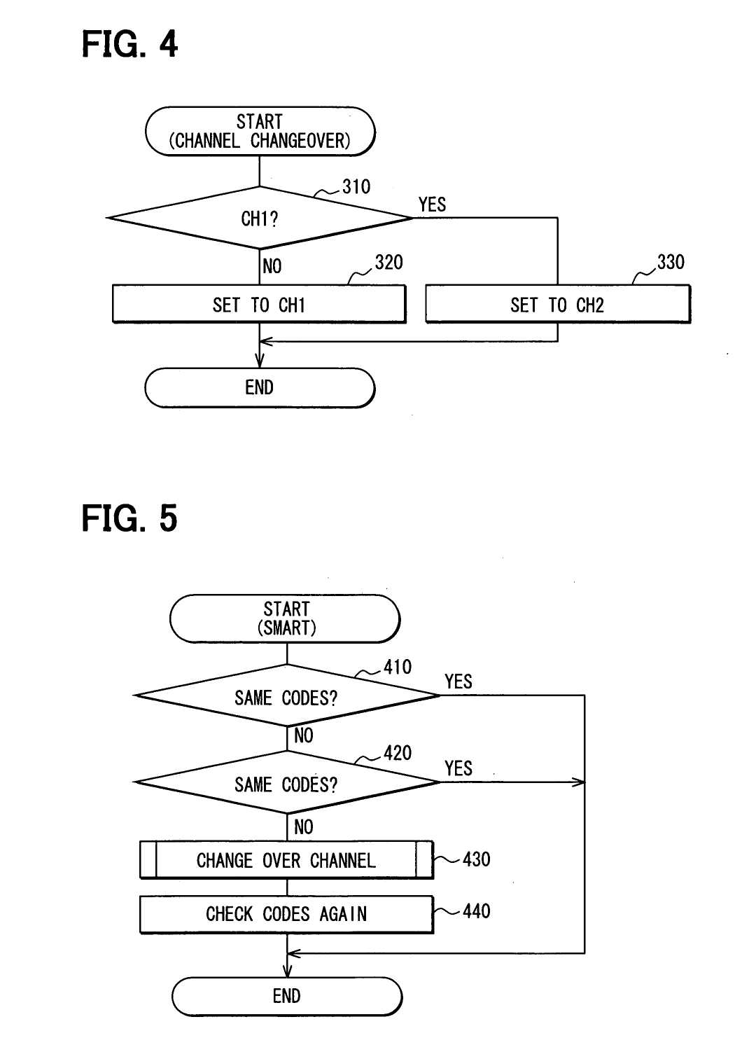

On the other hand, when it is determined in step 210 that the lock code or the unlock code which is included in the demodulated signal does not coincide with the code specific to the vehicle, the processing is then shifted to step 220 to change over the receiving channel. More specifically, the receiving channel changeover processing shown in FIG. 4 is executed.

In the receiving channel changeover processing shown in FIG. 4, it is first determined in step 310 whether the channel that has been set as the receiving channel is Ch1 or not. Then, when it is determined that the channel that has been set as the receiving channel is not Ch1, it is determined that the channel that has been set as the receiving channel is Ch2, the processing is shifted to step 320, and the receiving channel is set to Ch1.

On the other hand, when it is determined that the channel that has been set as the receiving channel is Ch1, the processing is shifted to step 330, and the receiving channel is set to Ch2.

Then, after the above receiving channel changeover processing is executed in step 220, the processing is advanced to step 230. In step 230, a code included in the demodulated signal of the radio signal which has been transmitted through the channel that has been changed over in the receiving channel changeover processing of step 220 is checked against the code specific to the vehicle. Thereafter, the above processing is completed. As a result of checking, when the codes coincide with each other, a signal indicative of this fact is input to the smart check ECU 5 to execute a given vehicle control. When the codes do not coincide with each other, a communication error is issued.

In the case of the communication of the smart entry system, the control IC 38 executes the process shown in FIG. 5. First in step 410, the smart code included in the demodulated signal is checked against the code specific to the vehicle, and it is determined whether both of those codes are the same coinciding with each other or not. When it is determined that those codes coincide with each other, a signal indicative of that fact is input to the smart check ECU 5. The smart check ECU 5 determines that the smart code coincides with the specific code on the basis of the input signal, and unlocks the door.

On the other hand, when it is determined in step 410 that the smart code included in the demodulated signal does not coincide with the code specific to the vehicle, the processing is then shifted to step 420, and the same processing as that in step 410 is conducted. As a result of checking, when it is determined that those codes coincide with each other, a signal indicative of that fact is input to the smart check ECU 5 thus completing the above processing.

On the other hand, in step 420, when it is determined that the smart code included in the demodulated signal does not coincide with the code specific to the vehicle, the processing is then shifted to step 430 to change over the receiving channel. More specifically, the above receiving channel changeover processing shown in FIG. 4 is executed.

Subsequently, the processing is shifted to step 440, and the smart code included in the demodulated signal of the radio signal which has been transmitted through the channel that has been changed over in the receiving channel changeover processing in step 430 is checked again against the code specific to the vehicle. Thereafter, the above processing is completed. As a result of checking, when the smart code coincides with the specific code, a signal indicative of this fact is input to the smart check ECU 5 to execute the unlocking of the door. When the codes do not coincide with each other, a communication error is issued.

As described above, in the vehicle control system 1 according to this embodiment, the control IC 38 executes the processing shown in FIG. 2, and determines one of channels Ch1 and Ch2, which is smaller in the noise level (channel whose communication state is excellent). When the noise level of Ch1 is smaller, the control IC 38 controls the frequency of the signal that is input to the mixer 28 from the PLL circuit 36 to the frequency for converting the first transmission radio wave into the intermediate frequency signal. On the other hand, when the noise level of Ch2 is smaller, the control IC 38 controls the frequency of the signal that is input to the mixer 28 from the PLL circuit 36 to the frequency for converting the second transmission radio wave into the intermediate frequency signal.

That is, because the first transmission radio wave and the second transmission radio wave are demodulated by a shared circuit, the configuration of the integrated tuner 4 can be simplified.

Also, because the demodulated signal of the radio signal of the channel that is smaller in the noise level is acquired from the radio signals that are transmitted from the smart portable device 2, the probability that data (the smart code, the lock code, or the unlock code) which is transmitted from the smart portable device 2 can be precisely received is improved. Hence, it is possible to more surely conduct the communication.

Also, the integrated tuner 4 checks the smart code, the lock code, and the unlock code which are transmitted from the smart portable device 2 against the specific code, respectively. As a result of checking, when those codes do not coincide with the code specific to the vehicle, the integrated tuner 4 changes over the receiving channel, and checks the smart code, the lock code, or the unlock code which has been received through the changed receiving channel against the specific code. For that reason, the probability that the checking is successful, that is, the communication is surely conducted can be improved.

In this embodiment, the remote keyless entry system and the smart entry system correspond to a keyless entry system, the smart portable device 2 corresponds to the portable device, the first transmission radio wave and the second transmission radio wave correspond to a keyless radio signal, and the integrated tuner 4, the smart check ECU 5, and the antenna 6 correspond to an in-vehicle receiving device. Also, the antenna 20 corresponds to a receiver antenna of the in-vehicle receiving device, and the processing in step 110 to step 130 of FIG. 2 corresponds to channel determining means, particularly, the processing in step 120 and step 130 corresponds to noise level detecting means. Further, the mixer 28, the PLL circuit 36, and the control IC 38 correspond to a frequency converter circuit, the demodulator circuit 32 corresponds to a demodulator circuit, the control IC 38 corresponds to control means, and the processing of step 220 and the processing of step 430 correspond to optimum channel changing means.

In this embodiment, the processing shown in FIGS. 2 to 5 can be executed in cooperation with the control IC 38 and the smart check ECU 5. For example, first, in the processing shown in FIG. 2, the processing of step 110 to step 130 can be executed by the smart check ECU 5. In this case, the control IC 38 inputs a signal that has been detected from the receiver IC 4a in the non-radio wave state to the smart check ECU 5. The smart check ECU 5 measures the noise levels of Ch1 and Ch2 on the basis of the input signal (step 110 and step 120), and compares the noise levels with each other (step 130). Then, the comparison result (Yes or No in step 130) is input to the control IC 38. Then, the control IC 38 executes the processing of step 140 or step 150 on the basis of the input comparison result.

Also, in the processing of FIGS. 3 to 5, the checking process (step 210, step 230, step 410, step 420, and step 440) can be executed by the smart check ECU 5. In this case, the control IC 38 inputs the demodulated signal to the smart check ECU 5. The smart check ECU 5 checks the codes against each other on the basis of the input demodulated signal, and determines whether those codes coincide with each other or not (step 210, step 410, and step 420), and then inputs the determination result to the control IC 38. On the basis of the input determination result, the control IC 38 executes the process of changing over the receiving channel when the codes do not coincide with each other (step 220, step 420, and FIG. 4), and then inputs the demodulated signal after the receiving channel has been changed over to the smart check ECU 5. The smart check ECU 5 checks the codes against each other on the basis of the input demodulated signal (step 230 and step 440).

### (First Modification)

The first embodiment may be modified so that the integrated tuner 4 receives the first transmission radio wave and the second transmission radio wave, measures the signal intensities of the respective signals, and sets the channel that is larger in the signal strength as the receiving channel.

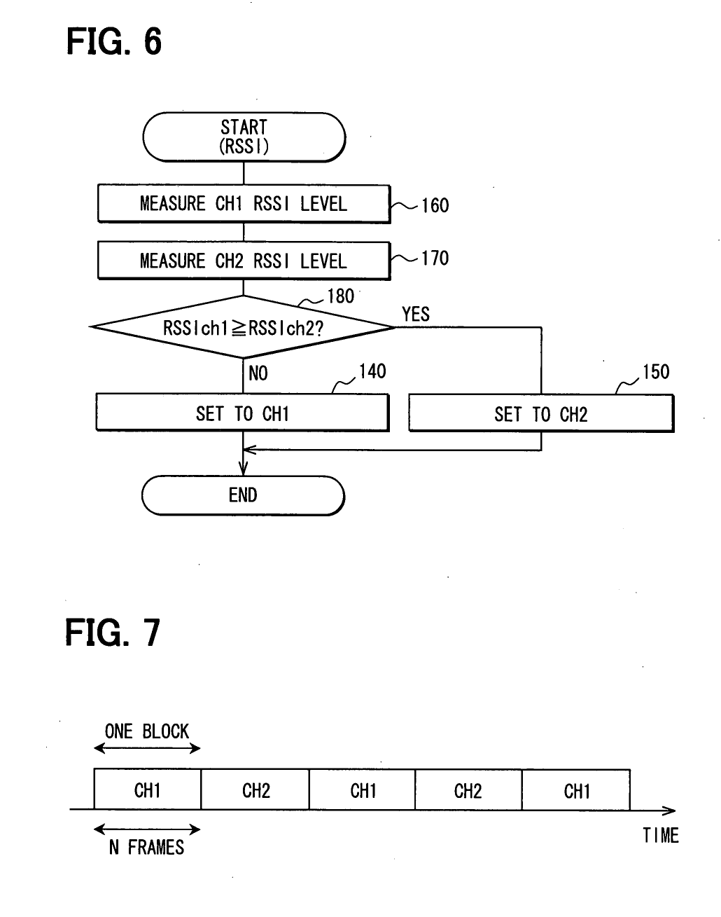

First, in the remote keyless entry system and the smart entry system, an inquiry signal is periodically transmitted to the smart portable device 2 from the antenna 6 through the processing (not shown) which is executed by the smart check ECU 5. Then, a reply signal is transmitted from the smart portable device 2 that has received the inquiry signal through Ch1 and Ch2, and the reply signal is received in the integrated tuner 4. Then, the control IC 38 periodically executes the processing of FIG. 6 in correspondence with a timing of transmitting the inquiry signal instead of the processing of FIG. 2. The steps of the same processing shown in FIG. 2 are denoted by identical symbols.

In the processing of FIG. 6, the signal strength (RSSI level) of the first transmission radio wave is first measured as RSSIch1 in step 160. More specifically, a voltage level of the demodulated signal of the first transmission radio wave that has been received by the antenna 20 is measured. Then, the signal strength of the second transmission radio wave is similarly measured as RSSIch2 in step 170.

Then, the processing is advanced to step 180, and it is determined whether or not the signal strength RSSIch1 of the first transmission radio wave is equal to or higher than the signal strength RSSIch2 of the second transmission radio wave. When it is determined whether the signal strength of the first transmission radio wave is equal to or higher than the signal strength of the second transmission radio wave, the processing is shifted to step 140, and the receiving channel is set to Ch1. On the other hand, when it is determined that the signal strength of Ch1 is not equal to or higher than the signal strength of Ch2, that is, the signal strength of Ch2 is higher than the signal strength of Ch1, the processing is shifted to step 150, and the receiving channel is set to Ch2. The setting contents are identical with that described above.

In the first modified example, the control IC 38 transmits a signal that commands a change in the signal strength to the smart portable device 2 from the antenna 6 by means of the smart check ECU 5 in the processing of step 140 and step 150. For example, when the signal strength is smaller, the control IC 38 transmits a signal representative of a command for increasing the signal strength to the smart portable device 2. Also, the control IC 38 transmits a signal representative of a command for decreasing the signal strength to the smart portable device 2 when the communication state is excellent and the signal strength can be low, or when the noise component is intended to be suppressed. The above processing corresponds to change command notifying means. Also, that signal can be transmitted together with the inquiry signal or a request signal in the smart entry system.

On the other hand, in the smart portable device 2, when a signal that commands a change in the signal strength is received by the antenna 10, the control IC 14 controls the amplification level in a transmission module on the basis of that signal, and changes the signal strength. Also, the control IC 38 transmits the signal that commands the change in the signal strength, and also controls the gain (amplification level) of the amplifier 26.

As described above, in this modification, the channel whose communication state is more excellent between Ch1 and Ch2 is determined by measuring the RSSI level. Then, the demodulated signal of the determined Ch is acquired. For this reason, the communication can be more surely conducted.

Also, the signal strength of the radio signal which is transmitted from the smart portable device 2 and the gain of the amplifier 26 are controlled, thereby making it possible to precisely transmit or receive data.

The processing of step 160 to step 180 in FIG. 6 corresponds to channel determining means, and more particularly, the processing of step 160 and step 170 corresponds to signal strength detecting means.

The processing of step 160 to step 180 in FIG. 6 can be executed by the smart check ECU 5. In this case, the control IC 38 inputs a signal (a signal representative of the voltage level of the demodulated signal) that is input from the receiver IC 4a to the smart check ECU 5. The smart check ECU 5 measures the signal intensities of Ch1 and Ch2 on the basis of the input signal (step 160 and step 170), and also compares the signal intensities with each other (step 180). Then, the smart check ECU 5 inputs the comparison result (Yes or No in step 160) to the control IC 38. Then, the control IC 38 executes the processing of step 140 or step 150 on the basis of the input comparison result.

Also, the processing (step 140 and step 150) for changing the signal strength can be executed by the smart check ECU 5. In addition, the smart check ECU 5 can execute the processing for controlling the gain of the receiver IC 4a.

### (Second Modification)

The first embodiment may further be modified such that the smart portable device 2 continuously transmits the first transmission radio wave and the second transmission radio wave at timing when the first transmission radio wave and the second transmission radio wave do not overlap with each other as shown in FIG. 7. One block consists of n frames, and each of those frames includes a signal representative of a code (smart code, lock command code, or unlock command code).

In the integrated tuner 4, both of the first transmission radio wave and the second transmission radio wave are received by the antenna 20. Then, the radio signal of one channel that has been set as the receiving channel in advance, and a code (smart code, lock command code, or unlock command code) represented by the demodulated signal is checked against the code specific to the vehicle, and when the codes do not coincide with each other, the receiving channel is changed over.

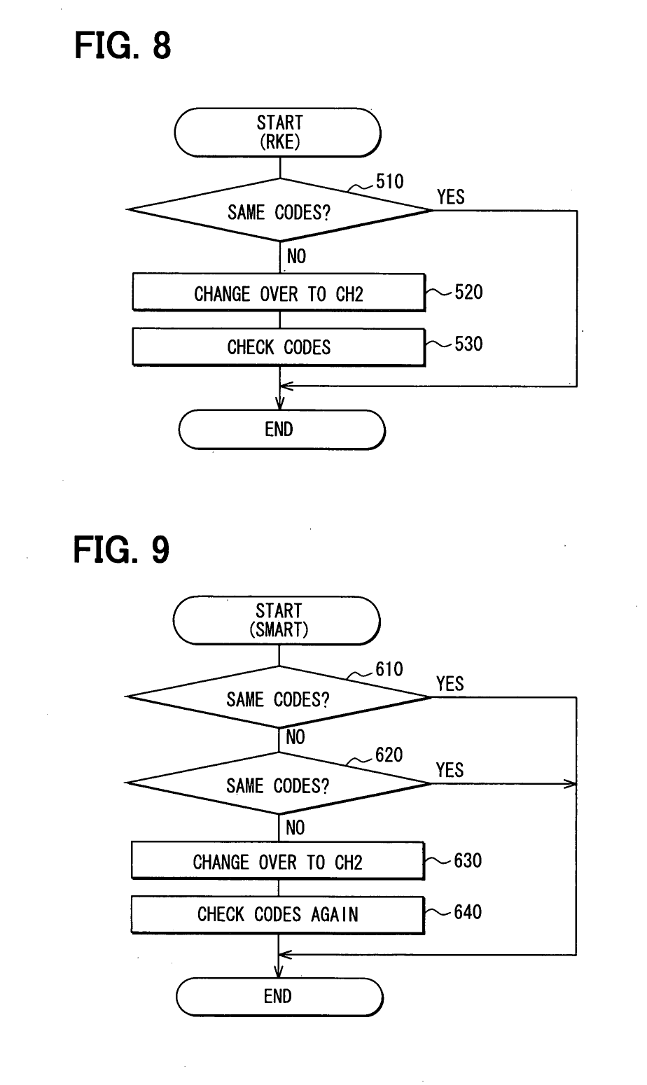

For this reason, the processing of FIGS. 8 and 9 is executed. In this case, it is possible that the processing of FIG. 2 or 6 is first executed, and the receiving channel is set, or the receiving channel of a default is set. It is assumed here that Ch1 is set as the receiving channel by the default. In this case, the first transmission radio wave that has been received by the antenna 20 is demodulated.

The processing of FIG. 8 is executed by the control IC 38 in the communication of the remote keyless entry system. First in step 510, the lock code or the unlock code which is included in the demodulated signal of the first transmission radio wave is checked against the code specific to the vehicle. It is determined whether those codes coincide with each other or not. When it is determined that those codes are the same coinciding with each other, a signal representative of this fact is input to the smart check ECU 5.

On the other hand, when it is determined in step 510 that the lock code or the unlock code does not coincide with the code specific to the vehicle, the processing is then shifted to step 520 to change over the receiving channel to Ch2.

Then, the processing is advanced to step 530, and the lock code or the unlock code which is included in the demodulated signal of the second transmission radio wave is checked again against the code specific to the vehicle. Thereafter, the above processing is completed. As a result of checking, when the lock code or the unlock code coincides with the specific code, a signal indicative of this fact is input to the smart check ECU 5 to execute the locking or unlocking of the door. When the lock code or the unlock code does not coincide with the specific code, a communication error is issued.

Subsequently, the control IC 38 executes the process shown in FIG. 9 in communication of the smart entry system by the control IC 38. It is assumed here that Ch1 is set as the receiving channel. First, in step 610, the smart code included in the demodulated signal is checked against the code specific to the vehicle, and it is determined whether those codes coincide with each other or not. When it is determined that those codes coincide with each other, a signal indicative of that fact is input to the smart check ECU 5.

On the other hand, in step 610, when it is determined that the smart code included in the demodulated signal does not coincide with the code specific to the vehicle, the processing is then shifted to step 620, and the same processing as that in step 610 is executed. When it is determined that those codes coincide with each other as a result of checking, a signal indicative of that fact is input to the smart check ECU 5.

On the other hand, in step 620, when it is determined that the smart code included in the demodulated signal does not coincide with the code specific to the vehicle, the processing is then shifted to step 630 to change over the receiving channel to Ch2.

Subsequently, the processing is shifted to step 640, and the smart code included in the demodulated signal of the second transmission radio wave is checked against the code specific to the vehicle. Thereafter, the above processing is completed. When the smart code coincides with the specific code as a result of checking, a signal indicative of this fact is input to the smart check ECU 5 to execute the unlocking of the door. When the smart code does not coincide with the specific code, a communication error is issued.

As described above, in the second modification, both of the first transmission radio wave and the second transmission radio wave are continuously transmitted from the smart portable device 2, and it is determined whether or not the code (smart code, lock command code, or unlock command code) that is included in the demodulated signal of the radio signal of the receiving channel that has been set in advance coincides with the code specific to the vehicle. When those codes do not coincide with each other, the receiving channel is changed over, and the code (smart code, lock command code, or unlock command code) that is included in the demodulated signal of the radio signal of the receiving channel that has been changed over is checked against the code specific to the vehicle. For this reason, when no error occurs in at least one of the demodulated signals of the first transmission radio wave and the second transmission radio wave, the checking is successful, that is, the communication is conducted.

In FIGS. 8 and 9, the checking process (step 510, step 530, step 610, step 620, and step 640) can be executed by the smart check ECU 5. In this case, the demodulated signal can be input to the smart check ECU 5 from the control IC 38.

### Second Embodiment

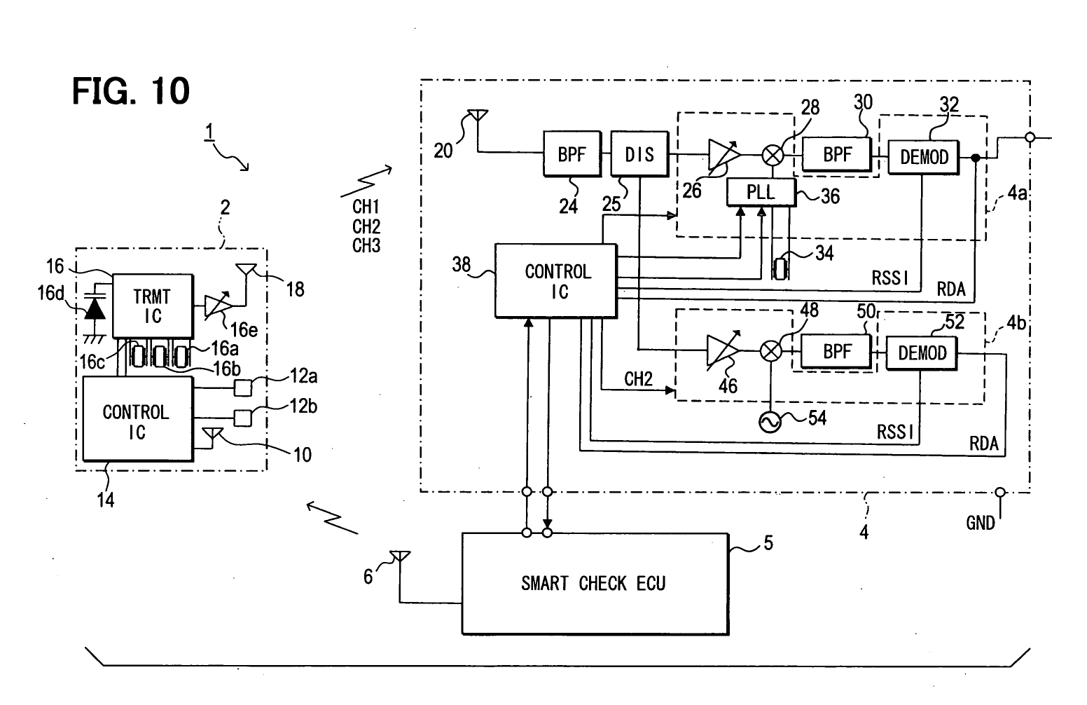

The second embodiment is configured as shown in FIG. 10, and different from the first embodiment in that the smart portable device 2 has an oscillator in each of the frequency channels. More particularly, oscillators 16b and 16c are provided in addition to the oscillator 16a. The oscillator 16a corresponds to the channel Ch1, the oscillator 16b corresponds to the channel Ch2, and the oscillator 16c corresponds to the channel Ch3. The frequency band of the Ch3 is 316.55 MHz.

Also, the smart portable device 2 is so configured as to transmit the radio signal of Ch1 (first transmission radio wave), the radio signal of Ch2 (second transmission radio wave), and the radio signal of the Ch3 (third transmission radio wave) at the same time. More specifically, the transmission IC 16 combines the signals for Ch1 to Ch3 together.

Further, the integrated tuner 4 includes a distributor circuit 25, a band pass filter (BRF) 50, an oscillator circuit 54, and a receiver IC 4b. The distributor circuit 25 is disposed between the BPF 24 and the receiver IC 4a, and distributes the radio signal that has been received by the antenna 20 to two routes. One of the signals that have been distributed by the distributor circuit 25 is input to the same receiver IC 4a as that in the first embodiment.

Then, another signal that has been distributed by the distributor circuit 25 is input to the receiver IC 4b. The receiver IC 4b includes an amplifier circuit (AMP) 46 that amplifies the input signal, a mixer 48 that mixes the received signal from the amplifier 46 with a signal having a constant local frequency (in this example, 303.65 MHz) which is input from the oscillator circuit 54 to convert the received signal into an intermediate frequency signal having a specific frequency, and a demodulator circuit 52 that demodulates the intermediate frequency signal of the specific frequency which has passed through the BPF 50. The control IC 38 detects the demodulated signal that is output from the receiver IC 4b, in more detail, the demodulator circuit 52. In addition, the control IC 38 detects the signal strength and the noise level as described above.

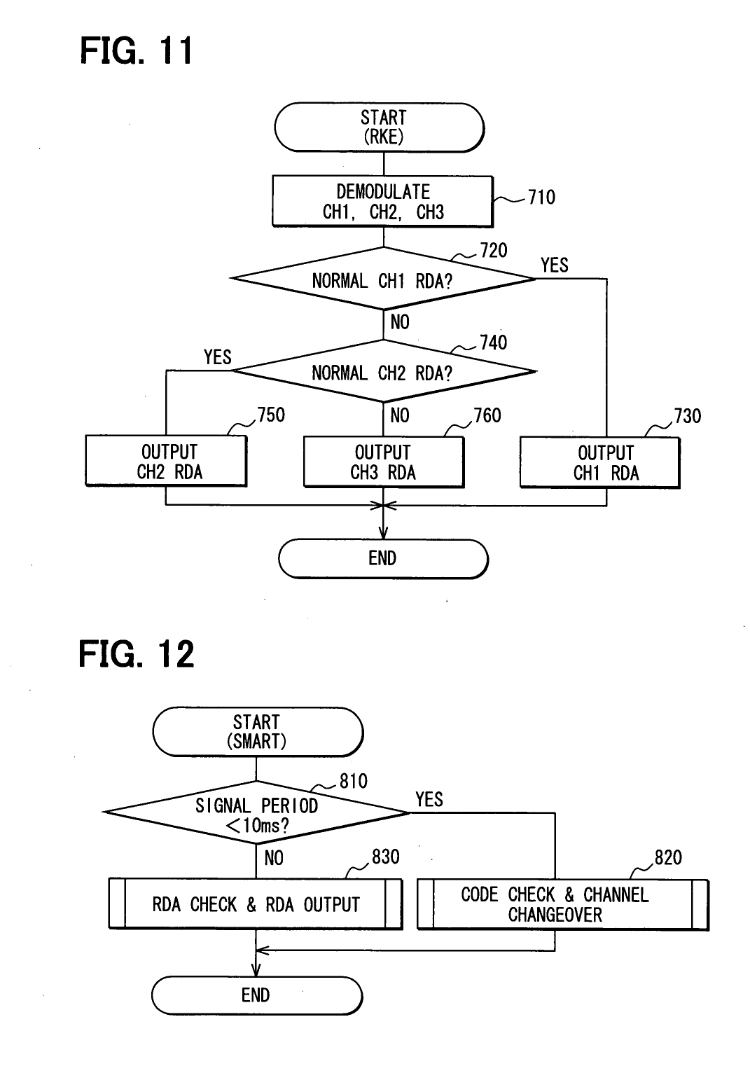

In the second embodiment, the control IC 38 executes a process shown in FIG. 11 in the communication of the remote keyless entry system. Upon receiving the first to third transmission radio waves, the control IC 38 first executes a process of demodulating the first to third transmission radio waves in step 710. The first or third transmission radio wave is demodulated at the receiver IC 4a side, and the second transmission radio wave is demodulated at the receiver IC 4b side.

More specifically, at the receiver IC 4a side, the input signal to the PLL circuit 36 is controlled, and a signal of a given local frequency (in this example, 301.45 MHz or 305.85 MHz) is input to the mixer 28.

In the receiver IC 4a, the first transmission radio wave (312.15 MHz), the second transmission radio wave (314.35 MHz), and the third transmission radio wave (316.55 MHz) are mixed with the signal of the local frequency (301.45 MHz or 305.85 MHz) by means of the mixer 28. When the transmission radio waves are mixed with the signal that is 301.45 MHz in the local frequency, the first transmission radio wave is converted into the intermediate frequency signal of 10.7 MHz. Also, when the transmission radio waves are mixed with the signal that is 305.85 MHz in the local frequency, the third transmission radio wave is converted into the intermediate frequency signal of 10.7 MHz. Then, the intermediate frequency signal passes through the BPF 30, and is input to the demodulator circuit 32.

On the other hand, at the receiver IC 4b side, the oscillator circuit 54 that generates a signal that is input to the mixer 48 of the receiver IC 4b oscillates at a given local frequency (303.65 MHz) as described above.

In the receiver IC 4b, the first transmission radio wave (312.15 MHz), the second transmission radio wave (314.35 MHz), and the third transmission radio wave (316.55 MHz) are mixed with the signal of the local frequency (303.65 MHz) by means of the mixer 28. Then, the second transmission radio wave is converted into the intermediate frequency signal of 10.7 MHz, and the intermediate frequency signal passes through the BPF 50, and is input to the demodulator circuit 52.

Subsequently, in step 720, it is determined whether the demodulated signal RDA of Ch1 is normal or not. For example, when it is detected that the demodulated signal is partially missing or incomplete or an undesired signal component is included in the demodulated signal, it is determined that an error exists in the demodulated signal. When the demodulated signal is not partly missing, or no undesired signal component is included in the demodulated signal, it is determined that the demodulated signal is normal.

When it is determined whether the demodulated signal of Ch1 is normal in step 720, the processing is shifted to step 730, and the demodulated signal of Ch1 is output to the smart check ECU 5.

On the other hand, when it is determined that the demodulated signal of Ch1 is not normal in step 720, the processing is shifted to step 740, and it is determined whether the demodulated signal of Ch2 is normal or not. When it is determined that the demodulated signal of Ch2 is normal, the processing is shifted to step 750, and the demodulated signal of Ch2 is output to the smart check ECU 5.

Also, when it is determined that the demodulated signal of Ch2 is not normal in step 740, the processing is shifted to step 760, and the demodulated signal RDA of the Ch3 is output to the smart check ECU 5.

When the demodulated signal is normal, it is assumed that the communication state is excellent. Then, in the processing of step 710 to step 760, the channel whose communication state is excellent is determined by determining whether the demodulated signal is normal or not, from a different viewpoint.

Then, the smart check CU 5 checks the lock command code or the unlock command code which is included in the input demodulated signal against the code specific to the vehicle. Then, when the smart check CU 5 determines that both of the codes coincide with each other, the smart check CU 5 executes the locking or unlocking of the door. The check of the codes (the lock command code or the unlock command code) can be executed by the control IC 38. In this case, a signal representative of coincidence or inconsistence is input to the smart check ECU 5 from the control IC 38. The smart check ECU 5 executes the vehicle control on the basis of the input signal.

In the communication of the smart entry system, the control IC 38 executes a process shown in FIG. 12. The signals that are transmitted from the smart portable device 2 have two kinds of signals consisting of a reply signal of a short period (shorter than 10 ms) to the request signal that is transmitted from the antenna 6 by processing of the control IC 38 or the smart check ECU 5, and a signal of a long period of time (equal to or longer than 10 ms) which is transmitted, for example, after the reply signal has been transmitted.

In the above processing, it is first determined in step 810 whether or not the signal that is transmitted from the smart portable device 2 is the short-period signal (smaller than 10 ms). More specifically, when the data represented by the signal is small in the data volume for short-period communication, it is determined that the signal is the reply signal of the short period. On the other hand, when the data represented by the signal is large in the data volume for long-period communication (larger in the data volume than the reply signal), it is determined that the signal is the signal of the long period.

When it is determined that the signal is the reply signal of the short period, the processing is shifted to step 820, and the processing of FIG. 5 is executed. On the other hand, when it is determined that the signal is not the reply signal of the short period, that is, is the signal of the long period, the processing is shifted to step 830, and the same processing as FIG. 11 is executed. In this case, in the receiving channel changeover processing which is executed in step 430 of FIG. 5, the channel is changed over to any one of channels Ch1 to Ch3.

As described above, according to the second embodiment, because the normal demodulated signal among the demodulated signals of the first to third transmission radio waves is checked, the probability that the check is successful can be improved. Hence, the communication can be more surely conducted. Also, the first transmission radio wave and the second transmission radio wave, or the third transmission radio wave and the first transmission radio wave can be demodulated in the respective combinations at the same time, which is advantageous.

In this embodiment, the smart portable device 2 corresponds to a portable device, the first to third transmission radio waves correspond to keyless radio signals, and the integrated tuner 4, the smart check ECU 5, and the antenna 6 correspond to an in-vehicle receiving device. Also, the antenna 20 corresponds to a receiver antenna of the in-vehicle receiving device, the processing of step 720 and step 740 corresponds to channel determining means, and the mixer 28, the PLL circuit 36, and the control IC 38 correspond to a first frequency converter circuit. Further, the mixer 48 and the oscillator circuit 54 correspond to a second frequency converter circuit, the demodulator circuit 32 corresponds to a first demodulator circuit, the demodulator circuit 52 corresponds to a second demodulator circuit, and the control IC 38 corresponds to control means of claim 5.

The processing of step 810 can be executed by the smart check ECU 5. In this case, the determining result in the processing of step 810 is input to the control IC 38 from the smart check ECU 5. The control IC 38 can be so configured as to execute the processing of FIG. 5 (step 820) or the processing of FIG. 11 (step 830).

### Third Embodiment

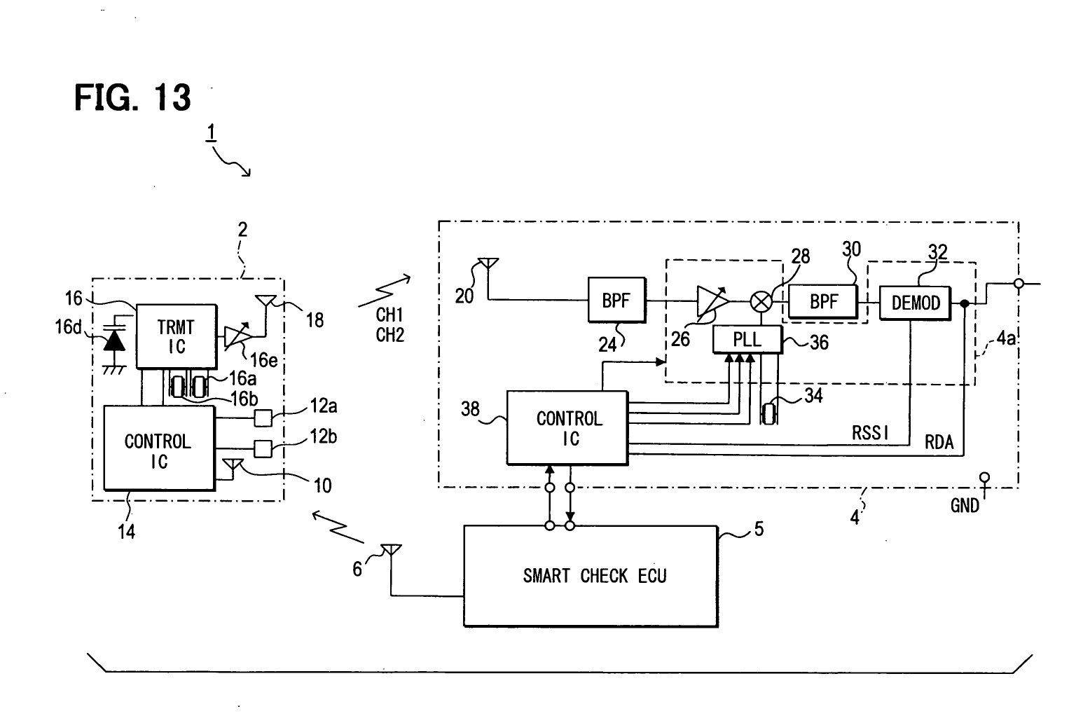

In the third embodiment, as shown in FIG. 13, the vehicle control system 1 is different from that of the first embodiment in that the smart portable device 2 has an oscillator in each of the frequency channels, more specifically, an oscillator 16b is disposed in addition to the oscillator 16a.

Also, the smart portable device 2 is so configured as to transmit the first transmission radio wave and the second transmission radio wave at the same time. More specifically, the transmission IC 16 is so configured as to combine the signals for two channels Ch1 and Ch2 together.

On the other hand, the control IC 38 periodically executes the processing of FIG. 2 while the ignition switch is off, and sets the receiving channel in advance. In the communication of the remote keyless entry system, the processing of FIGS. 3 and 4 is executed. In the communication of the smart keyless entry system, the processing of FIGS. 5 and 4 is executed.

The receiving channel can be set through the processing of FIG. 6. Also, the processing of FIGS. 3 to 6 is conducted as described above, and its description will be omitted.

In the third embodiment, the first transmission radio wave and the second transmission radio wave which are transmitted from the smart portable device 2 can be received by sharing a receiver circuit (antenna 20, receiver IC 4a). Hence it is possible to suppress the upsized configuration of the integrated tuner 4 and therefore the entire system, and an increase in the costs.

In the case of acquiring the demodulated signal of the radio signal that is transmitted from the smart portable device 2, because the demodulated signal of the radio signal of the channel that is smaller in the noise level (or the channel that is larger in the RSSI level) is acquired, the probability that the data (smart code, lock command code, or unlock command code) which is transmitted from the portable device 2 can be precisely received can be improved. Hence, the communication can be more surely conducted.

### (Third Modification)

The third embodiment may be modified as the third modification so that the control IC 38 executes the processing of FIG. 8 in the communication of the remote keyless entry system, and executes the processing of FIG. 9 in the communication of the smart entry system, instead of the processing of FIGS. 2 to 6. In this case, the control IC 38 is capable of executing the processing of FIG. 2 or 6, and setting the receiving channel in advance. Also, the receiving channel can be set by default. The processing of FIGS. 8 and 9 is conducted as described above.

In the third modification, it is determined whether or not the code (smart code, lock command code, or unlock command code) that is included in the demodulated signal of the radio signal of the receiving channel that has been set in advance coincides with the code specific to the vehicle. When those codes do not coincide with each other, the receiving channel is changed over, and the code (smart code, lock command code, or unlock command code) that is included in the demodulated signal of the radio signal of the receiving channel that has been changed over is checked against the code specific to the vehicle. For this reason, when no error occurs in at least one of the demodulated signals of the first transmission radio wave and the second transmission radio wave, the checking is successful, that is, the communication is conducted, which is advantageous.

### (Fourth Modification)

The third embodiment may be modified as the fourth modification so that the control IC 38 executes the processing of FIG. 11 in the communication of the remote keyless entry system, and executes the processing of FIG. 12 in the communication of the smart entry system, instead of the processing of FIGS. 3 to 5. In this case, when it is determined that the demodulated signal of Ch1 is abnormal in step 720 in the processing of FIG. 11, the demodulated signal of Ch2 is input to the smart check ECU 5 (step 740: Yes, step 750).

In the fourth modification, because the normal demodulated signal among the demodulated signals of the first transmission radio wave and the second transmission radio wave are checked, the probability that the check is successful can be improved. Hence, the communication can be more surely conducted.

The above embodiments and modifications may further be altered or varied.

For example, four frequencies Ch1 to Ch4 can be employed. In this situation, the number of frequencies Ch that are not handled by the receiver IC 4a may be two or more. However, the receiver IC 4b is so configured as to alternatively select any one from the radio signals of two or more Ch, and demodulate the selected one, or the receiver IC can be provided in each of the Ch.

In the second and third embodiments, the first to third transmission radio waves (the first and second transmission radio waves in the third embodiment) may not be transmitted at the same time, but can be transmitted in such a manner that their transmission periods do not overlap with each other.

In the first or third embodiment, it is possible that the radio signal of Ch1 is transmitted when the logical value is 1, and the radio signal of Ch2 is transmitted when the logical value is 0 according to the logical values of the respective bits of the smart code, the lock code, or the unlock code. Also, the logical values of the subsequent bits can be included in the respective radio signals.

In the above embodiments, the control IC 38 detects the signal strength of the demodulated signal. Alternatively, for example, an RSSI (received signal strength indicator) circuit for detecting the signal strength of the demodulated signal can be additionally provided. In this case, the signal strength that has been detected by the RSSI circuit can be input to the control IC 38.

In the above embodiments, the keyless entry system can be constituted by any one of the remote keyless entry system or the smart entry system. Also, the smart entry system can be so configured as to periodically transmit the request signal.

In the smart entry system, it is possible that in turning off an ignition switch to stop an engine, the receiving channel that has been set in the receiving channel setting process (FIGS. 2 and 6) is stored in advance, and thereafter in turning on the ignition switch, the radio signal is received at the stored receiving channel. In this case, the receiving channel setting process (FIGS. 2 and 6) can be executed a given period of time after the ignition switch turns on.

Also, in the above embodiments, the smart portable device 2 can be formed of a double-mode surface acoustic wave (SAW) oscillator disclosed in, for example, U.S. Pat. No. 6,384,698 (WO 00/67374). The double-mode SAW oscillator outputs a signal of a given frequency band, but a frequency of its output signal is shifted according to the applied voltage. When the double-mode SAW oscillator of this type is disposed in each channel, and the frequency is shifted according to the data to be transmitted, communication is realized between the smart portable device 2 and the integrated tuner 4. Because the 2-mode SAW oscillator can be packaged in an IC, when the double-mode SAW oscillator is used, the configuration of the smart portable device 2 can be simplified, and the size of the smart portable device 2 can be reduced.

What is claimed is:

1. A vehicle control system comprising:
a portable device that is carried by a user of a vehicle, and transmits a keyless radio signal for a keyless entry system for remotely controlling a device of the vehicle at a plurality of channels that are different in frequency from each other; and
an in-vehicle receiving device that is mounted in the vehicle and receives the keyless radio signal,
wherein the in-vehicle receiving device includes:
a receiver antenna for receiving the keyless radio signal;
channel determining means for determining an optimum channel having a best communication state among the plurality of channels;
a frequency converter circuit that selects any keyless radio signal of the plurality of channels among the signals that are received by the receiver antenna to convert the selected keyless radio signal into an intermediate frequency signal of a specific frequency;
a demodulator circuit that demodulates the intermediate frequency signal that is output from the frequency converter circuit; and
control means for allowing the frequency converter circuit to select the keyless radio signal of the optimum channel which is determined by the channel determining means.

2. The vehicle control system according to claim 1, wherein:
the frequency converter circuit includes;
a mixer that mixes the signal that is received by the receiver antenna with a conversion signal to convert any keyless radio signal of the plurality of channels into the intermediate frequency signal of the specific frequency, and
a circuit that generates the conversion signal, and
the frequency converter circuit changes over from a frequency of the conversion signal to a frequency for allowing any keyless radio signal of the plurality of channels to be converted into the intermediate frequency signal of the specific frequency by the mixer.

3. The vehicle control system according to claim 1, wherein:
the in-vehicle receiving device includes channel notifying means for notifying the portable device of the optimum channel that is determined by the channel determining means; and
the portable device transmits the keyless radio signal of the optimum channel that is notified by the channel notifying means.

4. The vehicle control system according to claim 1, wherein:
the channel determining means includes noise level detecting means for detecting a noise level of the received signal that is received by the antenna with respect to the plurality of channels; and
the channel determining means determines a channel having a lowest noise level as an optimum channel on the basis of the detection result of the noise level detecting means.

5. The vehicle control system according to claim 1, wherein:
the channel determining means includes signal strength detecting means for detecting a signal strength of the received signal that is received by the antenna with respect to the plurality of channels; and
the channel determining means determines a channel having the largest signal strength as an optimum channel on the basis of the detection result of the signal strength detecting means.

6. The vehicle control system according to claim 1, wherein:
the in-vehicle receiving device includes optimum channel changing means for checking a code included in the demodulated signal of the keyless radio signal against a code specific to the vehicle, and changing the optimum channel that is determined by the channel determining means when the two codes do not coincide with each other.

7. The vehicle control system according to claim 1, wherein:
the in-vehicle receiving device includes change command notifying means for notifying the portable device of a command for changing a signal strength of the keyless radio signal; and
the portable device changes the signal strength of the keyless radio signal on the basis of the change command of the signal strength which is notified by the change command notifying means.

8. A vehicle control system comprising:
a portable device that is carried by a user of a vehicle, and transmits a keyless radio signal for a keyless entry system for remotely controlling a device of the vehicle at a plurality of channels that are three or more and different in frequency from each other; and
an in-vehicle receiving device that is mounted in the vehicle and receives the keyless radio signal,
wherein the portable device combines the keyless radio signals of the plurality of channels together, and transmits a combined signal at the same time; and
wherein the in-vehicle receiving device includes;
a receiver antenna for receiving the keyless radio signal,
a first frequency converter circuit that selects any keyless radio signal of the plurality of channels among the signals that are received by the receiver antenna to convert a selected keyless radio signal into an intermediate frequency signal of a specific frequency,
a second frequency converter circuit that converts the keyless radio signal of the channel that is not handled by the first frequency converter circuit into an intermediate frequency signal of a specific frequency,
a first demodulator circuit that demodulates the intermediate frequency signal which is output from the first frequency converter circuit, and
a second demodulator circuit that demodulates the intermediate frequency signal which is output from the second frequency converter circuit.

9. The vehicle control system according to claim 8, wherein:
the first frequency converter circuit includes;
a mixer that mixes the signal that is received by the receiver antenna with a conversion signal to convert any keyless radio signal of the plurality of channels into the intermediate frequency signal of the specific frequency, and
a circuit that generates the conversion signal, and
the first frequency converter circuit changes over from a frequency of the conversion signal to a frequency for allowing any keyless radio signal of the plurality of channels to be converted into the intermediate frequency signal of the specific frequency by the mixer.

10. The vehicle control system according to claim 8, wherein:
the in-vehicle receiving device includes;
channel determining means for determining an optimum channel having a best communication state from the plurality of channels, and
control means for allowing the first frequency converter circuit to select the keyless radio signal of the optimum channel which is determined by the channel determining means, and acquires the demodulated signal which is output from the first demodulator circuit when the optimum channel that is determined by the channel determining means is a channel that is handled by the first frequency converter circuit, and acquires the demodulated signal which is output from the second demodulator circuit when the optimum channel that is determined by the channel determining means is a channel that is handled by the second frequency converter circuit.

11. The vehicle control system according to claim 8, wherein:
the channel determining means includes noise level detecting means for detecting a noise level of the received signal that is received by the antenna with respect to the plurality of channels; and
the channel determining means determines a channel having a lowest noise level as an optimum channel on the basis of the detection result of the noise level detecting means.

12. The vehicle control system according to claim 8, wherein:
the channel determining means includes signal strength detecting means for detecting a signal strength of the received signal that is received by the antenna with respect to the plurality of channels; and
the channel determining means determines a channel having the largest signal strength as an optimum channel on the basis of the detection result of the signal strength detecting means.

13. The vehicle control system according to claim 8, wherein:
the in-vehicle receiving device includes optimum channel changing means for checking a code included in the demodulated signal of the keyless radio signal against a code specific to the vehicle, and changing the optimum channel that is determined by the channel determining means when the two codes do not coincide with each other.

14. The vehicle control system according to claim 8, wherein:
the in-vehicle receiving device includes change command notifying means for notifying the portable device of a command for changing a signal strength of the keyless radio signal; and
the portable device changes the signal strength of the keyless radio signal on the basis of the change command of the signal strength which is notified by the change command notifying means.
